(19) United States
(12) Patent Application Publication
(10) Pub. No.: US 2024/0363298 A1
(43) Pub. Date: Oct. 31, 2024

(54) GAS CIRCUIT BREAKER

(71) Applicants: KABUSHIKI KAISHA TOSHIBA, Tokyo (JP); TOSHIBA ENERGY SYSTEMS & SOLUTIONS CORPORATION, Kawasaki-shi Kanagawa (JP)

(72) Inventors: Kei MAESHIMA, Kawasaki Kanagawa (JP); Yuko IMAZAWA, Yokohama Kanagawa (JP); Tomoyuki YOSHINO, Yokohama Kanagawa (JP); Toshiyuki UCHII, Yokohama Kanagawa (JP); Takanori IIJIMA, Yokohama Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi Kanagawa (JP)

(21) Appl. No.: 18/767,165

(22) Filed: Jul. 9, 2024

Related U.S. Application Data
(63) Continuation of application No. PCT/JP2022/000530, filed on Jan. 11, 2022.

(51) Int. Cl. H01H 33/91

(52) U.S. Cl. CPC H01H 33/91

(57) ABSTRACT

A gas circuit breaker of an embodiment includes an airtight container, a first arc contact and a second arc contact, an operation mechanism, and a spray unit. The first arc contact and the second arc contact are separated from each other for opening in a pole-open state. The operation mechanism separates the first arc contact from the second arc contact for opening. The spray unit sprays the arc-quenching gas accumulated under pressure to an arc discharge firing between the first arc contact and the second arc contact in the pole-open state after a state transitions from the pole-closed state to the pole-open state. A discharge channel that allows the space between the first arc contact and the second arc contact to communicate with an exhaust port formed at a position away from the contacts includes an accelerated taper in which a channel cross-sectional area of the discharge channel widens in a stepped shape from a position at which the first arc contact comes in contact with the second arc contact in the pole-closed state toward the exhaust port. A start point corner part and an end point corner part of a channel forming surface forming the discharge channel are rounded, the start point corner part and the end point corner part being located at a start point and an end point of the accelerated taper.

### TECHNICAL FIELD

An embodiment of the present invention relates to a gas circuit breaker.

### BACKGROUND ART

A gas circuit breaker that switches a current on or off in an electric power system interrupts the current by mechanically disconnecting the contacts. When the contacts are disconnected in the course of interrupting a current, an arc discharge occurs between the contacts. Such a gas circuit breaker quenches an arc discharge by spraying an arc-quenching gas to the arc discharge.

Here, a gas circuit breaker of the related art will be described using FIGS. 1 and 2. FIG. 1 is a diagram illustrating an input state of a gas circuit breaker of the related art. FIG. 2 is a diagram illustrating a state of a gas circuit breaker of the related art in the middle of a current interrupting operation. The gas circuit breaker 100 includes a movable arc contact 101 and a fixed arc contact 102 that are disposed to face each other as illustrated in FIG. 1. The movable arc contact 101 is hollow. A movable conduction contact 103 and a fixed conduction contact 104 are provided outside the movable arc contact 101 and the fixed arc contact 102. An insulating nozzle 105 is provided between the movable arc contact 101 and the movable conduction contact 103.

All the movable arc contact 101, the movable conduction contact 103, and the insulating nozzle 105 are fixed to a puffer cylinder 106. An operation rod 107 is connected to one end side of the puffer cylinder 106. The operation rod 107 is hollow. The puffer cylinder 106 and the operation rod 107 are connected to an operation mechanism 109 via an insulating rod 108. A puffer piston 110 is stored in the puffer cylinder 106 in a slidable manner. The puffer piston 110 is supported by a piston support 111. The puffer cylinder 106, the operation rod 107, and the puffer piston 110 constitute a puffer chamber 112.

An outflow passage 113 through which an arc-quenching gas flowing out from the puffer chamber 112 flows is formed between the insulating nozzle 105 and the movable arc contact 101. Furthermore, a first discharge channel 114 is formed in the hollow portions of the movable arc contact 101 and the operation rod 107. An exhaust port 115 is provided at the operation rod 107 on the operation mechanism side, and the inside of the first discharge channel 114 communicates with the inside of the piston support 111 through the exhaust port 115. A second discharge channel 116 is formed inside the insulating nozzle 105 of the gas circuit breaker 100 in a pole-open state as illustrated in FIG. 2, and the outflow passage 113 communicates with each of the first discharge channel 114 and the second discharge channel 116. The second discharge channel 116 is not formed in the gas circuit breaker 100 in a pole-closed state.

The fixed arc contact 102 and the fixed conduction contact 104 of the gas circuit breaker 100 described so far are fixed parts, and the other parts, for example, the movable arc contact 101, the movable conduction contact 103, the insulating nozzle 105, the puffer cylinder 106, and the operation rod 107 are movable parts. These members are stored in an airtight container, which is not illustrated, filled with an arc-quenching gas.

When a pole-open operation starts to interrupt the current from the input state illustrated in FIG. 1, the movable parts move to the operation mechanism 109 side, which is not illustrated, that is, in the arrow Y1 direction illustrated in FIG. 1, and enters the pole-open state illustrated in FIG. 2. According to the movement of the movable parts, the inside of the puffer chamber 112 is compressed, and thus the gas pressure of the arc-quenching gas inside the puffer chamber 112 becomes higher. Furthermore, the arc-quenching gas inside the puffer chamber 112 has high pressure since the gas captures the thermal energy generated from an arc discharge E.

The arc-quenching gas having high pressure inside the puffer chamber 112 is ejected into the outflow passage 113. The ejected arc-quenching gas is sprayed to the arc discharge E produced between the movable arc contact 101 and the fixed arc contact 102 through the outflow passage 113. The arc-quenching gas sprayed to the arc discharge E is discharged away therefrom in both of directions of the first discharge channel 114 and the second discharge channel 116.

The arc-quenching gas that has passed through the first discharge channel 114 runs through the piston support 111 via the exhaust port 115 and then flows out to a tank space, which is not illustrated. The arc discharge E that has received the sprayed arc-quenching gas is cooled by the arc-quenching gas and eventually reaches arc quenching. The current interruption is completed as the arc discharge E is quenched.

In the above-described gas circuit breaker, it is important to sufficiently cool the arc discharge E in a thermally challenging duty such as in an event of large current interruption. However, although it is empirically known that the performance is improved by increasing the pressure inside the puffer chamber 112 (referred to as puffer chamber pressure below), the temperature of the arc-quenching gas to be sprayed to the arc changes depending on how thermal energy of the arc is captured. For this reason, there are cases in which the puffer chamber pressure is not necessarily proportional to thermal insulation performance. Thus, the gas circuit breakers of the related art have secured thermal insulation performance by increasing the puffer chamber pressure more than needed.

Incidentally, gas circuit breakers have tended to be miniaturized for the purpose of reducing the installation space and lowering cost. However, because an increase in the puffer chamber pressure requires an increase in the driving power by the operation mechanism or the weight of the members, which results in an increase in size of the apparatus and cost, it is difficult to meet the societal demand for miniaturization. Furthermore, there is also a problem that, if current interruption is performed a number of times, the insulating nozzle 105 wears, which leads to an increase in the flow rate of the second discharge channel 116, and a desired puffer chamber pressure will not be obtained.

With respect to the problems, recent research clarified that thermal insulation performance is heavily affected by a flow of a channel provided inside a contact, that is, a flow of the first discharge channel 114 in FIG. 1, and the performance is improved when the flow is as high as possible. Thus, as a technique of increasing the flow of the first discharge channel 114 to a high speed, a technique of making a shape of the movable arc contact into an appropriate shape has been proposed (see Patent Document 1).

FIG. 3 is a cross-sectional view of main parts of a gas circuit breaker of the related art in which the movable arc contact is set to have an appropriate shape. It has been proposed that, in the gas circuit breaker 120 illustrated in FIG. 3, by shortening a length L1 from a stagnation point 121 to a minimum cross-sectional part 123 of a tulip contact 122 to 5 mm to 20 mm, the pressure loss can be reduced and a steep pressure distribution can be formed, and thus a fast flow can be generated.

Furthermore, it has been proposed that, by setting a slit width of the tulip contact 122 to 0.6 to 1.0 mm or less, a gas leakage from the tulip contact 122 can be minimized, and thus the flow in the inner channel of the tulip contact 122 can be sped up. However, Patent Document 1 does not mention the internal structure of the tulip contact 122 and thus it is unclear.

For this reason, even if the pressure distribution at the stagnation point 121 and the minimum cross-sectional part 123 of the tulip contact 122 is set to be steep or a gas leakage from the tulip contact 122 is reduced, unless the internal shape of the tulip contact 122 is appropriate, shock waves and separation occur, and thus a fast flow will not be formed in the internal channel of the tulip contact 122. Therefore, it is difficult to enhance the thermal insulation performance.

### CITATION LIST

### Patent Document

### Patent Document 1

Specification of European Patent Application Publication No. 3576125

### SUMMARY OF INVENTION

### Technical Problem

The problem to be solved by the present invention is to provide a gas circuit breaker that realizes high thermal insulation performance.

### Solution to Problem

A gas circuit breaker of an embodiment includes an airtight container, a first arc contact and a second arc contact, an operation mechanism, and a spray unit. The airtight container is filled with an arc-quenching gas. The first arc contact and the second arc contact are provided to be able to come in contact with or be separated from each other in the airtight container, come in contact with each other in a pole-closed state, and are separated from each other for opening in a pole-open state. The operation mechanism separates the first arc contact from the second arc contact for opening from the pole-closed state to the pole-open state. The spray unit sprays the arc-quenching accumulated under pressure gas to an arc discharge firing between the first arc contact and the second arc contact in the pole-open state after a state transitions from the pole-closed state to the pole-open state. A discharge channel that allows a space between the first arc contact and the second arc contact in the pole-open state to communicate with an exhaust port is formed at a position away from the space between the first arc contact and the second arc contact. The discharge channel includes an accelerated taper in which a channel cross-sectional area widens in a slope shape from a position at which the first arc contact comes in contact with the second arc contact in the pole-closed state toward the exhaust port. A start point corner part and an end point corner part of a channel forming surface forming the discharge channel are rounded, the start point corner part and the end point corner part being located at a start point and an end point of the accelerated taper.

### BRIEF DESCRIPTION OF DRAWINGS

FIG. 1 is a cross-sectional view illustrating an input state of a gas circuit breaker of the related art.

FIG. 2 is a cross-sectional view illustrating a state of the gas circuit breaker of the related art in the middle of a current cutoff operation.

FIG. 3 is a cross-sectional view illustrating main parts of another gas circuit breaker of the related art.

FIG. 4 is a cross-sectional view illustrating a gas circuit breaker 1 according to a first embodiment.

FIG. 5 is a cross-sectional view illustrating a movable arc contact 11 according to the first embodiment.

FIG. 6 is a cross-sectional view illustrating a movable arc contact 50 according to a second embodiment.

FIG. 7 is a front view illustrating the movable arc contact 50 according to the second embodiment.

FIG. 8 is a cross-sectional view illustrating a movable arc contact 60 according to a third embodiment.

FIG. 9 is a front view illustrating the movable arc contact 60 according to an eighth embodiment of the third embodiment.

FIG. 10 is a cross-sectional view illustrating a movable arc contact 70 according to a fourth embodiment.

FIG. 11 is a cross-sectional view illustrating a movable arc contact 80 according to a fifth embodiment.

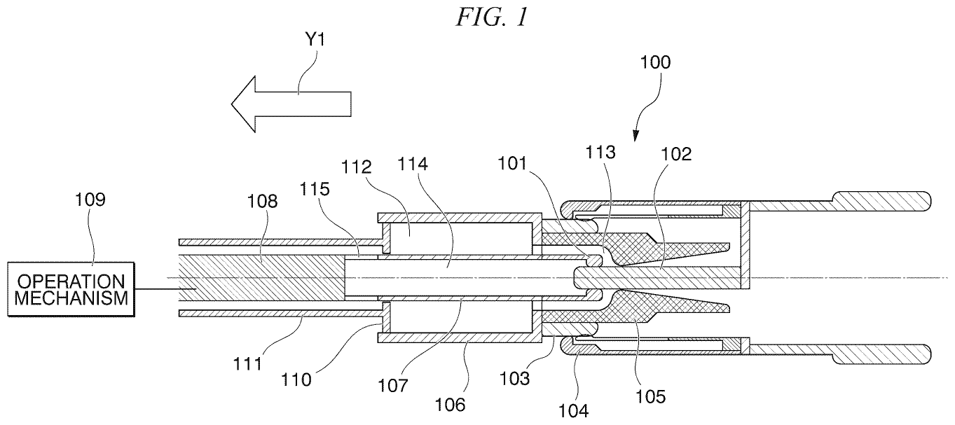

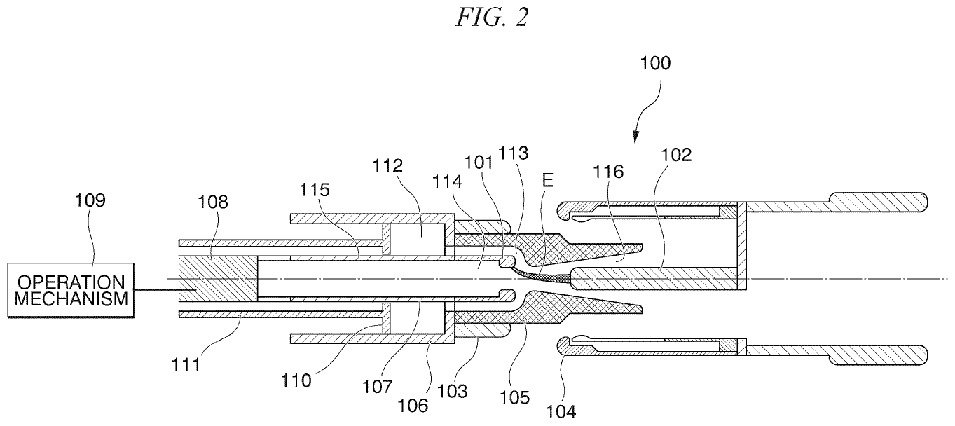

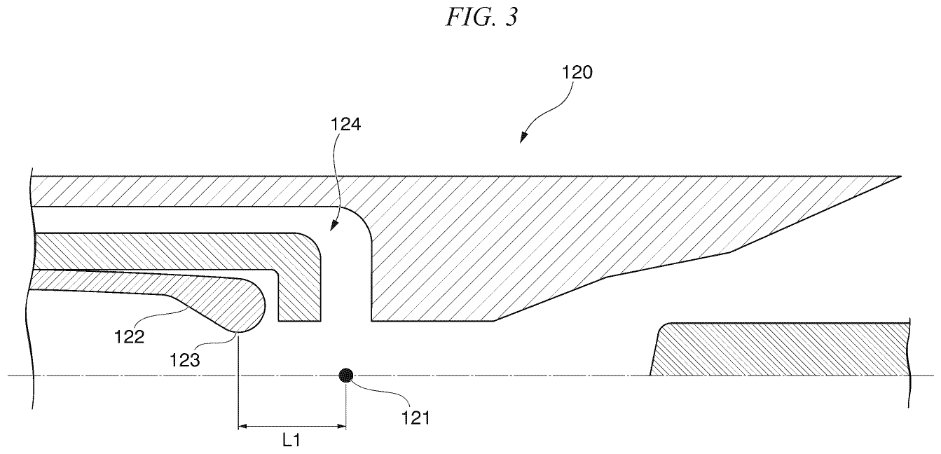

### DESCRIPTION OF EMBODIMENTS

A gas circuit breaker of an embodiment will be described below with reference to the drawings.

### First Embodiment

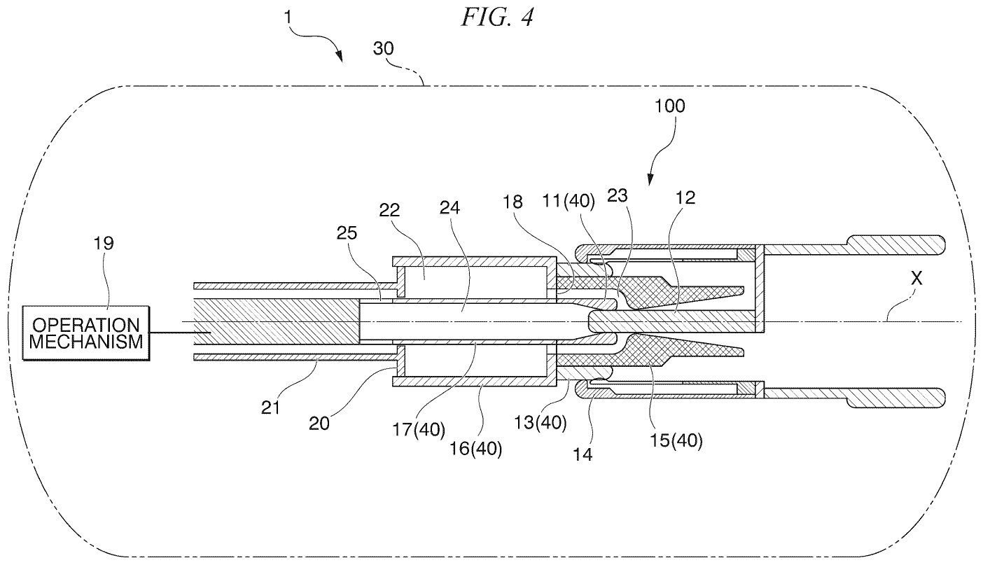

First, a first embodiment will be described. FIG. 4 is a cross-sectional view illustrating a gas circuit breaker 1 according to the first embodiment. The gas circuit breaker 1 according to the first embodiment includes, for example, a movable arc contact 11, a fixed arc contact 12, a movable conduction contact 13, a fixed conduction contact 14, an insulating nozzle 15, a puffer cylinder 16, an operation rod 17, an operation mechanism 19, a puffer piston 20, and a piston support 21. Each of these elements is housed in an airtight container 30 that is filled with an arc-quenching gas. Further, for convenience in description, the members housed in the airtight container 30 are depicted in a large size in FIG. 4.

All the movable arc contact 11, the fixed arc contact 12, the movable conduction contact 13, the fixed conduction contact 14, the insulating nozzle 15, the puffer cylinder 16, the operation rod 17, the puffer piston 20, and the piston support 21 form a shape of a rotating body rotated around a rotation axis X.

The movable arc contact 11 is a hollow columnar body, and the fixed arc contact 12 is a solid columnar body. The movable arc contact 11 and the fixed arc contact 12 are coaxially disposed. Both the movable arc contact 11 and the fixed arc contact 12 are conductors. In the following description, the side of the movable arc contact 11 where the fixed arc contact 12 is provided will be referred to as a tip side, and the side opposite to the tip side will be referred to as a tail side.

An opening having substantially the same shape as a cross-sectional shape of the fixed arc contact 12 (hereinafter, a tip opening) is formed at the end part of the tip side of the movable arc contact 11. The movable arc contact 11 and the fixed arc contact 12 are provided to be able to be separated from or come in contact with each other in the airtight container 30 as the movable arc contact 11 operates in a predetermined direction, for example, the axial direction of the operation rod 17 in the airtight container 30. The movable arc contact 11 and the fixed arc contact 12 come in contact with each other in a pole-closed state, and are separated from each other for opening in a pole-open state. The movable arc contact 11 is an example of a first arc contact. The fixed arc contact 12 is an example of a second arc contact.

Both the movable conduction contact 13 and the fixed conduction contact 14 are cylindrical conductors. The movable conduction contact 13 is disposed to cover the perimeter of the movable arc contact 11. The fixed conduction contact 14 is disposed to cover the perimeter of the fixed arc contact 12. The movable conduction contact 13 is separated from the movable arc contact 11, and a gap is formed between the movable arc contact 11 and the movable conduction contact 13. The movable conduction contact 13 has an outer diameter that is substantially the same as an inner diameter of the fixed conduction contact 14. The movable conduction contact 13 and the fixed conduction contact 14 are provided to be able to be separated from or come in contact with each other in the airtight container 30 as the movable conduction contact 13 operates in a predetermined direction.

The insulating nozzle 15 is formed in a cylindrical shape. The insulating nozzle 15 covers the surrounding of the movable arc contact 11 from a place near the tip side further to the tip side. The insulating nozzle 15 operates together with the movable arc contact 11. The insulating nozzle 15 surrounds an arc discharge firing at a position between the movable arc contact 11 and the fixed arc contact 12 in the pole-open state (referred to as an “arc discharge firing position” below).

The puffer cylinder 16 is a cylindrical body having a larger diameter than the movable arc contact 11. The puffer cylinder 16 is disposed at the tail end of the movable arc contact 11. An opening having a small diameter is formed at the tip side of the puffer cylinder 16, and an opening having a large diameter is formed at the tail side thereof. The insulating nozzle 15 is attached to the tip of the puffer cylinder 16.

The operation rod 17 is a conductor provided inside the puffer cylinder 16. The front part of the operation rod 17 is cylindrical-shaped having substantially the same diameter as that of the movable arc contact 11, and is connected to the tail side of the movable arc contact 11 coaxially with the movable arc contact 11. The operation rod 17 is fixed to the puffer cylinder 16. A hole part 18 is formed around the operation rod 17 at the front end part of the puffer cylinder 16. The rear part of the operation rod 17 is plate-shaped. In FIG. 4, a part of the rear part of the operation rod 17 is not illustrated.

The operation mechanism 19 includes, for example, a power source such as a motor, a linkage mechanism, or the like. The operation mechanism 19 is connected to the rear part of the operation rod 17. The operation mechanism 19 causes the operation rod 17 to operate in the axial direction thereof. Since the operation mechanism 19 causes the operation rod 17 to operate, the movable arc contact 11, the puffer cylinder 16, the insulating nozzle 15, and the movable conduction contact 13 (referred to as a “movable part 40” below) operate in the same direction. When the operation mechanism 19 causes the movable part 40 to operate, the movable arc contact 11 is separated from the fixed arc contact 12 for opening from the pole-closed state to the pole-open state.

The puffer piston 20 is a disk-shaped member in which an opening is formed at the center. The puffer piston 20 blocks the opening of the puffer cylinder 16 at the tail side. A diameter of the opening formed at the center of the puffer piston 20 is substantially the same as an outer diameter of the operation rod 17. The operation rod 17 operates in the axial direction through the opening formed in the puffer piston 20.

The piston support 21 is provided at the tail side of the puffer piston 20. The piston support 21 supports the puffer piston 20. The puffer piston 20 is fixed by being supported by the piston support 21.

A puffer chamber 22 is formed in the region surrounded by the puffer cylinder 16, the operation rod 17, and the puffer piston 20. Since the airtight container 30 is filled with an arc-quenching gas, the puffer chamber 22 is filled with the arc-quenching gas as well. When the movable part 40 operates to switch from the pole-closed state to the pole-open state, the volume of the puffer chamber 22 is reduced, and thus the arc-quenching gas is accumulated under pressure in the puffer chamber 22.

The hole part 18 formed in the puffer cylinder 16 communicates with the gap between the movable arc contact 11 and the insulating nozzle 15. The gap between the movable arc contact 11 and the insulating nozzle 15 serves as the outflow passage 23 through which the arc-quenching gas in the puffer chamber 22 flows out when the volume of the puffer chamber 22 is reduced.

A discharge part for the arc-quenching gas on the outflow passage 23 is located at an arc discharge firing position in the pole-open state. When the state is the pole-open state, the arc-quenching gas in the puffer chamber 22 is accumulated under pressure, passes through the outflow passage 23, and then discharged from the exhaust port of the outflow passage 23. An arc discharge is fired at the arc discharge firing position in the pole-open state. The outflow passage 23 allows the arc-quenching gas to spray against the arc discharge after the state transitions from the pole-closed state to the pole-open state. The puffer chamber 22 and the outflow passage 23 are an example of a stray unit.

The hollow portion of the movable arc contact 11 and the operation rod 17 in the pole-open state communicates with the tip opening of the movable arc contact 11. The hollow portion at the front of the movable arc contact 11 and the operation rod 17 forms a first discharge channel 24. The tail part at the front of the operation rod 17 includes an exhaust port 25.

The first discharge channel 24 is a cylindrical channel having a cylindrical shape. The first discharge channel 24 allows the arc discharge firing position in the pole-open state to communicate with the exhaust port 25. A heat gas generated due to the sprayed arc-quenching gas discharged through the outflow passage 23 to the arc discharge circulates in the first discharge channel 24. Since the exhaust port 25 is provided, a part of the generated heat gas flows into the first discharge channel 24 through the tip opening and is discharged from the exhaust port 25.

A gap is formed between the fixed arc contact 12 and the insulating nozzle 15 in the pole-open state. The gap between the fixed arc contact 12 and the insulating nozzle 15 forms a second discharge channel. The side of the second discharge channel opposite to the movable arc contact 11 side is open. For this reason, a part of the heat gas generated at the arc discharge firing position in the pole-open state flows into the second discharge channel, and is discharged from the side of the second discharge channel opposite to the movable arc contact 11 side.

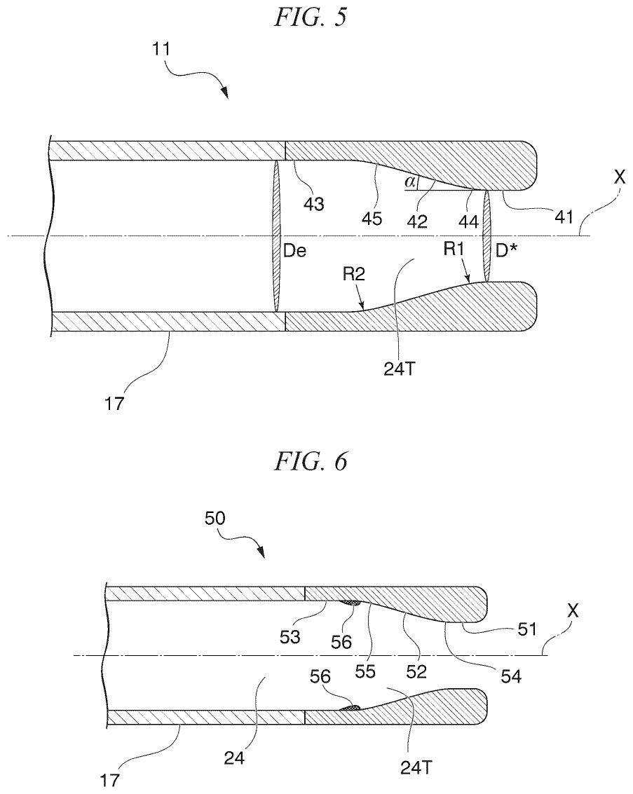

Next, details of the movable arc contact 11 will be described. FIG. 5 is a cross-sectional view of the movable arc contact 11 according to the first embodiment. The inner wall surface of the movable arc contact 11 includes a tip linear part 41, a tapered part 42, and a tail linear part 43. A first curved part 44 is formed between the tip linear part 41 and the tapered part 42, and a second curved part 45 is formed between the tapered part 42 and the tail linear part 43.

Both the tip linear part 41 and the tail linear part 43 are formed to be parallel with the rotation axis X of the movable arc contact 11. The tapered part 42 is formed as an accelerated taper 24T with a slope such that the portion of the first discharge channel 24 surrounded by the tapered part 42 has a channel cross-sectional area spreading in a slope shape from the position at which the movable arc contact 11 comes in contact with the fixed arc contact 12 in the pole-closed state toward the exhaust port 25. In other words, the accelerated taper 24T has a shape in which it spreads in a slope shape from upstream to downstream. The inner wall surface of the movable arc contact 11 is an example of a channel forming surface.

The first curved part 44 is located at the start point of the accelerated taper 24T, and the second curved part 45 is located at the end point of the accelerated taper 24T. The first curved part 44 is an example of a start point corner part. The second curved part 45 is an example of an end point corner part. Both the first curved part 44 and the second curved part 45 are rounded by curving. Only one of the first curved part 44 and the second curved part 45 may be provided.

The cross-sectional area of the movable arc contact 11 at the position corresponding to the tip linear part 41 (“first cross-sectional area” below) is the minimum cross-sectional area of the first discharge channel 24. The first cross-sectional area D* and the cross-sectional area at the position corresponding to the tail linear part 43 (“second cross-sectional area” below) De has a relation satisfying the following formula (1). Further, since the cross-section at the position corresponding to the tail linear part 43 has the same shape as that of the cross-section of the operation rod 17, the second cross-sectional area De is equal to the cross-sectional area of the operation rod 17.

$$De / {D}^{*} < 13.2 \qquad ( 1 )$$

In addition, a spread angle α of the tapered part 42 satisfies the following formula (2).

$$α < 34.4 ° \qquad ( 2 )$$

The spread angle α of the tapered part 42 is represented by an angle formed by the tapered part 42 and the rotation axis X.

Furthermore, a first curvature radius R1 that is a curvature radius of the first curved part 44 satisfies the following formula (3), and a second curvature radius R2 that is a curvature radius of the second curved part 45 satisfies the following formula (4).

$$R 1 > {( {D}^{*} / π )}^{1 / 2} \qquad ( 3 )$$

$$R 2 > R 1 \qquad ( 4 )$$

Next, operations and effects of the gas circuit breaker 1 according to the first embodiment will be described focusing on operations and effects of the movable arc contact 11. When there is a difference between pressure of the puffer chamber 22 and filling pressure inside the airtight container 30, an arc discharge is choked at the minimum cross-sectional area portion of the first discharge channel 24. In a general gas circuit breaker, a pressure ratio of pressure of the puffer chamber 22 and filling pressure of the airtight container 30 at the time of high current interruption is about 10. This pressure ratio is sufficient value of pressure at which an arc discharge is choked. For this reason, by providing the accelerated taper 24T surrounded by the tapered part 42 in the first discharge channel 24, the flow downstream the minimum cross-sectional area part of the first discharge channel 24 becomes supersonic, and thus a high-speed flow can be formed.

However, if the accelerated taper 24T is not appropriately configured, there is concern that the flow rate rapidly decreases due to occurrence of vertical shock waves resulting from over-expansion, occurrence of oblique shock waves resulting from flow separation or a change in the channel cross-sectional area, or the like in the first discharge channel 24. Thus, in order to prevent vertical shock waves resulting from over-expansion from occurring, for example, the following configuration can be employed.

Vertical shock waves are generated when a relation between a pressure ratio and a channel cross-sectional area ratio is not proper in acceleration of a supersonic flow resulting from the pressure difference as in the first embodiment and expansion using the accelerated taper 24T. Generally, the relation of the following formula (5) is established between a pressure Pw at a position at which vertical shock waves are generated, a pressure P0 of the puffer chamber, the channel cross-sectional area Dw at the position at which vertical shock waves are generated, and a first cross-sectional area (that is minimum cross-sectional area) D* of the first discharge channel 24.

$$\begin{matrix}[ Equation 1 ] & \\ \frac{{P}_{w}}{{P}_{0}} = \frac{2 {γM}_{w 1}^{2} - ( γ - 1 )}{γ + 1} {( 1 + \frac{γ - 1}{2} {M}_{w 1}^{2} )}^{- \frac{γ}{γ - 1}} & ( 5 )\end{matrix}$$

$$\frac{{D}_{w}}{{D}^{*}} = \frac{1}{{M}_{w 1}} {\{ \frac{( γ - 1 ) {M}_{w 1}^{2} + 2}{γ + 1} \}}^{\frac{γ + 1}{2 ( γ - 1 )}}$$

Wherein, Mw1 indicates a Mach number just before shock waves, and y indicates a specific heat ratio of a gas.

According to the above-described formula (5), for a general gas (having a specific heat ratio from 1.0 to 1.7), it is found that, when the channel cross-sectional area ratio Dw/D* is about 1.2 or greater, the pressure ratio Pw/P0 monotonically decreases with respect to the channel cross-sectional area ratio Dw/D*. For this reason, in the gas circuit breaker 1 of the first embodiment, the channel cross-sectional area ratio Dw/D* is set such that the pressure ratio Pw/P0 is not below a ratio of a filling pressure of the airtight container 30 and the pressure P0 of the puffer chamber 22.

As described above, a ratio of a pressure of the puffer chamber 22 and a filling pressure of the airtight container 30 at the time of high current interruption is about 10. In addition, the specific heat ratio of an arc-quenching gas that is generally used for gas circuit breakers is 1.4. Under these conditions, the occurrence of vertical shock waves can be prevented by setting the ratio De/D* between the first cross-sectional area D* and the second cross-sectional area De to a value less than 13.2.

Next, a configuration for preventing flow separation will be described. Flow separation is a phenomenon in which, when a flow expands, a slow flowing portion cannot resist a pressure difference between a decreased pressure resulting from the expansion and the filling pressure, and thus a backflow occurs. Here, when expansion acceleration is carried out due to the accelerated taper 24T, if the spread angle of the accelerated taper 24T is excessively high, the heat gas fails to expand, and thus an area with no flow is generated near the wall surface. Thus, by limiting the spread angle of the accelerated taper 24T, the area near the wall surface in which the heat gas does not flow, which causes separation, is prevented from being generated.

Generally, a relation between a maximum allowable spread angle αmax of the nozzle and the Mach number after spread can be expressed by the following formula (6) by using a Prandtl-Meyer function ν.

$$\begin{matrix}[ Equation 2 ] & \\ v = \sqrt{\frac{γ + 1}{γ - 1}} {tan}^{- 1} \sqrt{\frac{γ - 1}{γ + 1} ( {M}^{2} - 1 )} - {tan}^{- 1} \sqrt{{M}^{2} - 1} & ( 6 )\end{matrix}$$

$${α}_{max} = \frac{v}{2}$$

The above formula (6) indicates that the maximum allowable spread angle increases accordingly as the Mach number increases. When the channel cross-sectional area ratio Dw/C* is set to 13.2 as described above, the specific heat ratio is 1.4, the Mach number is 4.24, and thus the Prandtl-Meyer function vis 68.8°. Thus, the maximum allowable spread angle αmax of the nozzle is 34.4°. Therefore, by setting the spread angle α of the accelerated taper 24T to a value less than 34.4°, the occurrence of separation can be prevented.

In addition, when a channel is widened without having a curvature at the start point of the accelerated taper 24T, the boundary layer abruptly develops along the inner wall surface, and thus flow separation is likely to occur. To deal with such separation, in the gas circuit breaker 1 of the first embodiment, the first curvature radius R1 of the first curved part 44 located at the start point of the accelerated taper 24T on the inner wall surface of the movable arc contact 11 is set to exceed the radius of the minimum cross-sectional area of the first discharge channel 24, as indicated by the above formula (3). This setting of the first curvature radius R1 to exceed the radius of the minimum cross-sectional area of the first discharge channel 24 contributes to prevention of such flow separation.

Because the flow direction changes at the start point and the end point of the accelerated taper 24T of the movable arc contact 11, that is, the portion of the first curved part 44 and the second curved part 45, expansion waves and compression waves are generated, respectively. Since the compression waves generated at the portion of the second curved part 45 overlap each other to generate oblique shock waves, they lower the speed of the heat gas in the first discharge channel 24.

To deal with the decrease of the speed of the heat gas, in the gas circuit breaker 1 of the first embodiment, the second curvature radius R2 is set to be greater than the first curvature radius R1 as indicated by the above formula (4). The reason for the second curvature radius R2 being set to be greater than the first curvature radius R1 will be described below.

Compression waves generated at the end point of the accelerated taper 24T can be cancelled out by appropriately using expansion waves generated at the start point of the accelerated taper 24T. To use expansion waves generated at the start point of the accelerated taper 24T, the deflection angle of the flow when expansion waves are generated needs to be equal to the deflection angle of the wall surface at the end point of the accelerated taper 24T that the expansion waves reach.

By setting the deflection angle of the flow when expansion waves are generated to be equal to the deflection angle of the wall surface at the end point of the accelerated taper 24T that the expansion waves reach, the compression waves generated at the end point of the accelerated taper 24T are cancelled out by the expansion waves that have reached, and thus a flow creating no compression waves is made at the end point. In addition, expansion waves generated at the start point of the accelerated taper 24T advance to the wall surface of the end point at an angle lower than that when the expansion waves are generated with respect to the wall surface of the end point of the accelerated taper 24T due to interference between the expansion waves.

For this reason, the deflection angle of the wall surface at the end point of the accelerated taper 24T is required to be blunter than that at the start point of the accelerated taper 24T. Thus, the second curvature radius R2 located at the end point of the accelerated taper 24T is set to be greater than the first curvature radius R1 located at the start point of the accelerated taper 24T as indicated by the above formula (3).

Further, although the tip linear part 41 is provided and a portion in which the minimum cross-sectional area D* is uniform is set in the movable arc contact 11 in the gas circuit breaker 1 according to the first embodiment, the tip linear part 41 may not be provided. In addition, in the movable arc contact 11, although the accelerated taper 24T is provided only in the portion of the movable arc contact 11, the accelerated taper 24T may reach a portion of the operation rod 17.

According to the gas circuit breaker 1 of the first embodiment, a high-speed flow with no vertical shock waves, separation, and oblique shock waves can be realized in the entire first discharge channel 24. As a result, a gas circuit breaker having high thermal insulation performance without increasing the pressure inside the puffer chamber 22 more than necessary can be provided.

### Second Embodiment

Next, a second embodiment will be described.

The gas circuit breakers according to the second to fifth embodiments below are different from the gas circuit breaker 1 according to the first embodiment mainly in terms of the configuration of the movable arc contact, and other configurations are the same as those of the gas circuit breaker 1 according to the first embodiment. In the description of the second to fifth embodiments below, the gas circuit breaker according to the second embodiment will be described mainly focusing on differences from the first embodiment.

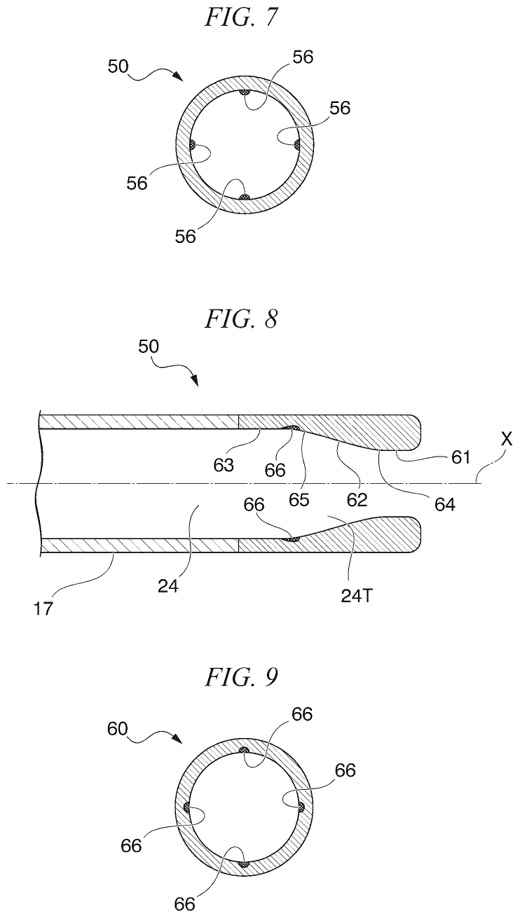

FIG. 6 is a cross-sectional view of a movable arc contact 50 according to the second embodiment. FIG. 7 is a front view of the movable arc contact 50 according to the second embodiment. The movable arc contact 50 of the second embodiment includes a tip linear part 51, a tapered part 52, a tail linear part 53, a first curved part 54, and a second curved part 55, similarly to the movable arc contact 11 of the first embodiment. The movable arc contact 50 of the second embodiment further includes multiple, for example, four, protrusions 56. The protrusions 56 are an example of unevenness.

All the four protrusions 56 are disposed at positions spanning between the second curved part 55 and the tail linear part 53. All the four protrusions 56 are evenly disposed in the circumferential direction of the movable arc contact 50 in the common cross-section part of the movable arc contact 50 at positions equally located in the flow direction of heat gas.

All the four protrusions 56 have the same shape. The portion of the movable arc contact 50 surrounded by the tapered part 52 excluding the protrusions 56 is formed as an accelerated taper 24T. Thus, the protrusions 56 are formed to project from the inner wall surface of the movable arc contact 50 toward the accelerated taper 24T.

Next, operations and effects of the gas circuit breaker according to the second embodiment will be described focusing on operations and effects of the movable arc contact 50. Flow separation is conceivable as a cause for a decrease in flow rate in the first discharge channel 24. Flow separation is caused by a decrease in the flow rate of the gas at a position very close to the wall surface due to viscosity of the gas. For this reason, separation can be prevented by making the flow at the position close to the wall surface into turbulence to maintain the flow rate.

The protrusions 56 provided in the movable arc contact 50 can intentionally disturb the flow of the heat gas near the inner wall surface of the first discharge channel 24 to make the flow into turbulence. The flow in the first discharge channel 24 made into turbulence can prevent flow separation, and contribute to formation of a high-speed flow without flow separation in the entire area of the first discharge channel 24.

Although the above-described effect is the same as that of the first embodiment, since the flow near the inner wall surface of the movable arc contact 50 is made into turbulence in the second embodiment, even if an area with a slow flow rate is locally generated near the wall surface for any reason in the first discharge channel 24, a flow with no separation can be formed in the entire area of the first discharge channel 24, and thus further effects resulting from the formation can be obtained.

Further, although the four protrusions 56 are evenly disposed in the circumferential direction in the movable arc contact 50 in the second embodiment, there is no limitation on the number and disposition method of the protrusions 56 as long as the effect of preventing flow separation can be obtained. In addition, although the four protrusions 56 are disposed only in one row at the positions equally located in the flow direction of the heat gas in the movable arc contact 50 in the second embodiment, the protrusions may be disposed at positions differently located with respect to the flow of the heat gas as long as the effect of preventing flow separation can be obtained. The protrusions 56 may have any shape as long as the shape can lead to the effect of preventing flow separation. The protrusions 56 may be located at positions other than the positions spanning between the second curved part 55 and the tail linear part 53. The protrusions 56 may be located at positions in either the second curved part 55 or the tail linear part 53, for example, positions of any of the tip linear part 51, the tapered part 52, and the first curved part 54, or positions spanning the parts.

### Third Embodiment

Next, a third embodiment will be described.

FIG. 8 is a cross-sectional view of a movable arc contact 60 according to the third embodiment. FIG. 9 is a front view illustrating the movable arc contact 60 according to an eighth embodiment of the third embodiment. The movable arc contact 60 of the third embodiment includes a tip linear part 61, a tapered part 62, a tail linear part 63, a first curved part 64, and a second curved part 65, similarly to the movable arc contact 11 of the first embodiment. The movable arc contact 60 of the third embodiment further includes multiple, for example, four, dimples 66 on the inner wall surface of the movable arc contact 50. The dimples 66 are an example of unevenness.

All the four dimples 66 are formed in the second curved part 65. All the four dimples 66 are evenly disposed in the circumferential direction of the movable arc contact 60 in the common cross-section part (positions that are same in the flow direction of the heat gas) in the movable arc contact 60. All the four dimples 66 have the same shape. The portion of the movable arc contact 60 surrounded by the tapered part 52 where no dimples 66 are formed is formed as an accelerated taper 24T. Thus, the dimples 66 are formed to be recessed from the accelerated taper 24T on the inner wall surface of the movable arc contact 60.

Next, operations and effects of the gas circuit breaker according to the third embodiment will be described focusing on operations and effects of the movable arc contact 60. The gas circuit breaker of the third embodiment can prevent separation by making the flow at the position close to the wall surface of the movable arc contact 60 into turbulence to maintaining the flow rate, similarly to the gas circuit breaker of the second embodiment.

The gas circuit breaker of the third embodiment can exhibit the same effects as those of the second embodiment since the dimples 66 are formed in the movable arc contact 60.

Further, although the four dimples 66 are evenly disposed in the circumferential direction in the movable arc contact 60 in the third embodiment, there is no limitation on the number and disposition method of the dimples 66 as long as the effect of preventing flow separation can be obtained. In addition, although the four dimples 66 are disposed only in one row at the positions equally located in the flow direction of the heat gas in the movable arc contact 60 in the third embodiment, the dimples may be formed at positions differently located with respect to the flow of the heat gas or may be formed in multiple rows as long as the effect of preventing flow separation can be obtained. The dimples 66 may have any shape as long as the shape can lead to the effect of preventing flow separation. The dimples 66 may be formed at positions other than those in the second curved part 65. Then dimples may be formed in, for example, the tip linear part 61, the tapered part 62, the tail linear part 63, or the first curved part 64, or at positions spanning the parts.

### Fourth Embodiment

Next, a fourth embodiment will be described.

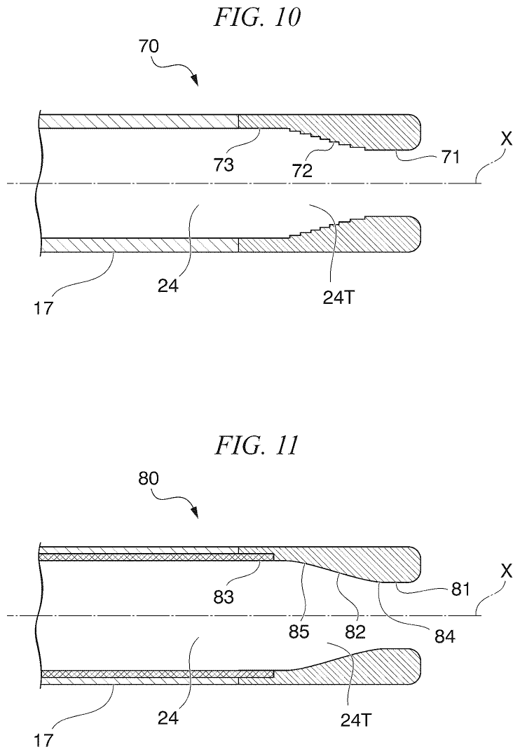

FIG. 10 is a cross-sectional view of a movable arc contact 70 according to the fourth embodiment. The movable arc contact 70 of the fourth embodiment includes a tip linear part 71 and a tail linear part 73, similarly to the movable arc contact 11 of the first embodiment. The movable arc contact 70 of the fourth embodiment includes a step-like widening part 72, instead of the tapered part 42 of the movable arc contact 11 of the first embodiment.

The step-like widening part 72 has a structure in which the tapered part 42 of the first embodiment widens in a stepped shape. To further describe, the step-like widening part 72 is formed as an accelerated widening part 24H in which the portion of the first discharge channel 24 surrounded by the step-like widening part 72 has a shape of a channel cross-sectional area widening from the position at which the movable arc contact 11 comes in contact with the fixed arc contact 12 in the pole-closed state toward the exhaust port 25. In other words, the accelerated widening part 24H has a shape in which the accelerated taper 24T of the first embodiment widens in a stepped shape from upstream to downstream.

Next, operations and effects of the gas circuit breaker according to the fourth embodiment will be described focusing on operations and effects of the movable arc contact 70. In the gas circuit breaker of the fourth embodiment, the accelerated widening part 24H has a shape in which the accelerated taper 24T of the first embodiment widens in a stepped shape is formed. Since the accelerated widening part 24H is formed, weak oblique shock waves can be generated on purposed in the first discharge channel 24. As a result, a significant decrease in the flow rate of the heat gas caused by flow separation can be prevented.

Since the accelerated widening part 24H is formed in the gas circuit breaker of the fourth embodiment, a high-speed flow with no significant decrease in flow rate caused by separation can be realized in the first discharge channel 24. Thus, the gas circuit breaker of the fourth embodiment can contribute to improvement in the thermal insulation performance.

Further, although the multiple steps are disposed in the step-like widening part 72 in the gas circuit breaker of the fourth embodiment, there is no limitation on the number and disposition method of the steps as long as the effect of generating weak oblique shock waves can be obtained. Furthermore, there is no limitation on a height of the steps in the step-like widening part 72 as long as the effect of generating weak oblique shock waves can be obtained. In addition, a tip part and a tail part of the step-like widening part 72 may be provided with the first curved part and the second curved part as in the first embodiment, or only one of them may be provided.

### Fifth Embodiment

Next, a fifth embodiment will be described.

FIG. 11 is a cross-sectional view of a movable arc contact 80 according to the fifth embodiment.

The movable arc contact 80 of the fifth embodiment includes a tip linear part 81, a tapered part 82, a tail linear part 83, a first curved part 84, and a second curved part 85, similarly to the movable arc contact 11 of the first embodiment. The movable arc contact 80 of the fifth embodiment further includes an insulating member 86. The insulating member 86 is a cylindrical member and is composed of an insulator.

The insulating member 86 is disposed in at least a part of the exhaust port 25 side on the inner wall surface of the movable arc contact 80 from the space between the movable arc contact 11 and the fixed arc contact 12 in the pole-open state, that is, in the fifth embodiment, over the operation rod 17 from the second curved part 85 of the movable arc contact 80. A recess to which the insulating member 86 fits is formed on the inner wall surface of the movable arc contact 80 and the operation rod 17, compared with the gas circuit breaker 1 of the first embodiment. The recess is formed to be flush by the inner wall surface of the movable arc contact 80 and the operation rod 17 and the insulating member 86 in the gas circuit breaker of the fifth embodiment.

Next, operations and effects of the gas circuit breaker according to the fifth embodiment will be described focusing on operations and effects of the movable arc contact 80. When an attachment part of an arc discharge E to the contact (movable arc contact 80) is pressed downstream the first discharge channel 24 by a flow of an arc-quenching gas in the first discharge channel 24, the arc discharge E may reach an area in which the flow rate decreases. In this case, the high-speed arc-quenching gas may not be sprayed to the arc discharge E, which may reduce the insulation performance. Due to this point, the insulating member 86 is provided in the gas circuit breaker of the fifth embodiment. Since the attachment part of the arc discharge E to the contact is not able to advance downstream from the position at which the channel surface serves as an insulator, the insulating member 86 is provided to enable a high-speed arc-quenching gas to be sprayed to the arc discharge E.

Since the insulating member 86 is provided on the inner wall surface of the movable arc contact 80 in the gas circuit breaker of the fifth embodiment, the high-speed gas can be sprayed to the arc discharge E. Thus, the gas circuit breaker of the fifth embodiment can further improve the thermal insulation performance.

Further, although the insulating member 86 is disposed at the end point of the accelerated taper 24T, that is, the second curved part 85 in the gas circuit breaker of the fifth embodiment, there is no limitation on a disposition position of the insulating member 86 as long as a high-speed gas can be sprayed to the arc discharge E. In addition, the insulating member 86 may be provided only in the movable arc contact 80, or only in the operation rod 17.

Although a first arc contact is the movable arc contact 11 and a second arc contact is the fixed arc contact 12 in the above-described embodiments, the first arc contact may be the fixed arc contact 12 and the second arc contact may be the movable arc contact 11. In this case, for example, the shapes of the movable arc contact 11 and the fixed arc contact 12 may be exchanged to form the exhaust port 25 at the front end part of the fixed arc contact 12.

According to at least one embodiment described above, in a gas circuit breaker including an airtight container that is filled with an arc-quenching gas, a first arc contact and a second arc contact provided to be able to come in contact with or be separated from each other in the airtight container to be in contact with each other in a pole-closed state and to be separated from each other for opening in a pole-open state, an operation mechanism that separates the first arc contact from the second arc contact for opening from the pole-closed state to the pole-open state, and a spray unit that sprays the arc-quenching gas accumulated under pressure to an arc discharge firing between the first arc contact and the second arc contact in the pole-open state after a state transitions from the pole-closed state to the pole-open state, in which a discharge channel that allows a space between the first arc contact and the second arc contact in the pole-open state to communicate with an exhaust port is formed at a position away from the space between the first arc contact and the second arc contact is formed, the discharge channel includes an accelerated taper in which a channel cross-sectional area widens in a slope shape from a position at which the first arc contact comes in contact with the second arc contact in the pole-closed state toward the exhaust port, and a start point corner part and an end point corner part of a channel forming surface forming the discharge channel are rounded, the start point corner part and the end point corner part being located at a start point and an end point of the accelerated taper, and thus high thermal insulation performance can be realized.

Although the several embodiments of the present invention have been described, these embodiments are presented as examples, and do not intend to limit the scope of the invention. These embodiments can be implemented in other various modes, and can be subject to various omission, replacement, and modification within the scope not departing from the gist of the invention. The embodiments and modified examples thereof are included in the scope and gist of the invention, and at the same time, included in the inventions described in the claims and the scope of equivalents thereof.

### REFERENCE SIGNS LIST

1 Gas circuit breaker
11, 50, 60, 70, 80 Movable arc contact
12 Fixed arc contact
13 Movable conduction contact
14 Fixed conduction contact
15 Insulating nozzle
16 Puffer cylinder
17 Operation rod
18 Hole part
19 Operation mechanism
20 Puffer piston
22 Puffer chamber
23 Outflow passage
24 First discharge channel
24H Accelerated widening part
24T Accelerated taper
25 Exhaust port
30 Airtight container
40 Movable part
41, 51, 61, 71, 81 Tip linear part
42, 52, 62, 82 Tapered part
43, 53, 63, 73, 83 Tail linear part
44, 54, 64, 84 First curved part
45, 55, 65, 85 Second curved part
56 Protrusion
72 Step-like widening part
86 Insulating member

What is claimed is:

1. A gas circuit breaker comprising:
an airtight container that is filled with an arc-quenching gas;
a first arc contact and a second arc contact provided to be able to come in contact with or be separated from each other in the airtight container to be in contact with each other in a pole-closed state and to be separated from each other for opening in a pole-open state;
an operation mechanism configured to separate the first arc contact from the second arc contact for opening from the pole-closed state to the pole-open state; and
a spray unit configured to spray the arc-quenching gas accumulated under pressure to an arc discharge firing between the first arc contact and the second arc contact in the pole-open state after a state transitions from the pole-closed state to the pole-open state,
wherein a discharge channel that allows a space between the first arc contact and the second arc contact in the pole-open state to communicate with an exhaust port formed at a position away from the space between the first arc contact and the second arc contact is formed,
the discharge channel includes an accelerated taper in which a channel cross-sectional area widens in a slope shape from a position at which the first arc contact comes in contact with the second arc contact in the pole-closed state toward the exhaust port, and
a start point corner part and an end point corner part of a channel forming surface forming the discharge channel are rounded, the start point corner part and the end point corner part being located at a start point and an end point of the accelerated taper.

2. The gas circuit breaker according to claim 1, wherein a curvature radius of the start point corner part is greater than a radius of a minimum cross-sectional area portion in the discharge channel, and a curvature radius of the end point corner part is greater than the curvature radius of the start point corner part.

3. The gas circuit breaker according to claim 1, wherein a cross-sectional area ratio of a cross-sectional area of the start point corner part and a cross-sectional area of the end point corner part is less than 13.2.

4. The gas circuit breaker according to claim 1, wherein a spread angle of the accelerated taper is lower than 34.4°.

5. The gas circuit breaker according to claim 1, wherein unevenness is formed on the channel forming surface.

6. A gas circuit breaker comprising:
an airtight container that is filled with an arc-quenching gas;
a first arc contact and a second arc contact provided to be able to come in contact with or be separated from each other in the airtight container to be in contact with each other in a pole-closed state and to be separated from each other for opening in a pole-open state;
an operation mechanism configured to separate the first arc contact from the second arc contact for opening from the pole-closed state to the pole-open state; and
a spray unit configured to spray the arc-quenching gas accumulated under pressure to an arc discharge firing between the first arc contact and the second arc contact in the pole-open state after a state transitions from the pole-closed state to the pole-open state,
wherein a discharge channel that allows a space between the first arc contact and the second arc contact in the pole-open state to communicate with an exhaust port formed at a position away from the space between the first arc contact and the second arc contact is formed, and
the discharge channel include an accelerated widening part in which a channel cross-sectional area of the discharge channel widens in a stepped shape from a position at which the first arc contact comes in contact with the second arc contact in the pole-closed state toward the exhaust port.

7. The gas circuit breaker according to claim 1, wherein an insulating member is disposed in at least a part of the exhaust port side on the channel forming surface forming the discharge channel from a space between the first arc contact and the second arc contact in the pole-open state.
